(19) United States
(12) Patent Application Publication
(10) Pub. No.: US 2026/0167154 A1
(43) Pub. Date: Jun. 18, 2026

(54) WIPING DEVICE

(71) Applicant: Chung-Wu Ting, New Taipei City (TW)

(72) Inventor: Chung-Wu Ting, New Taipei City (TW)

(21) Appl. No.: 19/070,462

(22) Filed: Mar. 4, 2025

(30) Foreign Application Priority Data
Dec. 18, 2024 (CN) 202411864513.7

(51) Int. Cl. B60S 1/34; B60S 1/26

(52) U.S. Cl. CPC B60S 1/3409; B60S 1/26

(57) ABSTRACT

A wiping device includes a wiping rod, a wiping member mounted on the wiping rod, a linking rod, a first transmission arm, a second transmission arm, a first linking arm and a second linking arm. The linking rod is parallel to the wiping rod. The first linking arm and the second linking arm are disposed between the linking rod and the wiping rod and parallel to each other. The first transmission arm and the first linking arm are rotatably connected to the linking rod and rotatably meshed with each other directly or indirectly. The first transmission arm is parallel to the second transmission arm. An extending line through rotating axes of transmission ends of the first transmission arm and the second transmission arm is parallel to or coincided with an extending line through rotating axes of cooperating ends of the first linking arm and the second linking arm.

### BACKGROUND OF THE INVENTION

### 1. Field of the Invention

The present invention relates to a wiping device, and more specifically, to a wiping device with simple structure, compact size, durability, and a wide wiping area.

### 2. Description of the Prior Art

A vehicle, such as a car, an airplane or a ship, is usually equipped with a wiping device configured to remove dust or water from a windshield of the vehicle for ensuring a clear view for a driver. However, the conventional wiping device only can provide a limited wiping area formed in a sector shape, which fails to cover corner portions of the windshield. Besides, the conventional wiping device requires a larger space in an engine compartment to accommodate a linkage mechanism for synchronization. Additionally, there are some improved wiping devices which utilize a horizontal wiping member capable of moving along a vertical direction or a vertical wiping member capable of moving along a horizontal direction to make a wiping area cover the corner portions of the windshield. However, such wiping device requires tracks, chains, or cables to restrict or drive movement of the wiping member. As a result, such wiping device is prone to failure due to sand accumulation, breakage, or wear and tear, and therefore is not durable. Furthermore, there is another improved wiping device which avoids using any track, chain or cable while offering a wider wiping area. However, such wiping device cannot be stored properly when not in use, thereby providing an obstructed view. Therefore, an improvement is needed.

### SUMMARY OF THE INVENTION

It is an objective of the present invention to provide a wiping device with simple structure, compact size, durability, and a wide wiping area.

In order to achieve the aforementioned objectives, the present invention discloses a wiping device. The wiping device includes a wiping rod, a wiping member, a linking rod, a first transmission arm, a second transmission arm, a first linking arm and a second linking arm. The wiping rod includes a first section and a second section opposite to the first section. The wiping member is mounted on the wiping rod. The linking rod includes a first end portion and a second end portion opposite to the first end portion. A length direction of the linking rod is parallel to a length direction of the wiping rod. The first transmission arm includes a first rotating end and a first transmission end opposite to the first rotating end and rotatably connected to the first end portion of the linking rod. The second transmission arm is arranged parallel to the first transmission arm. The second transmission arm includes a second rotating end and a second transmission end opposite to the second rotating end and rotatably connected to the second end portion of the linking rod. The first linking arm is disposed between the linking rod and the wiping rod and includes a first cooperating end and a first linking end. The first cooperating end is rotatably connected to the first end portion of the linking rod and rotatably meshed with the first transmission end of the first transmission arm directly or indirectly. The first linking end is rotatably connected to the first section of the wiping rod. The second linking arm is disposed between the linking rod and the wiping rod and includes a second cooperating end and a second linking end. The second cooperating end is rotatably connected to the second end portion of the linking rod and rotatably meshed with the second transmission end of the second transmission arm directly or indirectly. The second linking end is rotatably connected to the second section of the wiping rod. An extending line through a rotating axis of the first transmission end and a rotating axis of the second transmission end is parallel to or coincided with an extending line through a rotating axis of the first cooperating end and a rotating axis of the second cooperating end.

According to an embodiment of the present invention, the wiping device further includes at least one power source coupled to at least one of the first transmission arm and the second transmission arm.

According to an embodiment of the present invention, the at least one power source includes a first power source. The first power source includes a first driving member including a plurality of driving teeth, and the first rotating end of the first transmission arm is provided with a first driven member including a plurality of driven teeth configured to cooperate with the plurality of driving teeth.

According to an embodiment of the present invention, the at least one power source includes a first power source. The first power source includes a first driving member including a plurality of driving teeth. The first transmission end of the first transmission arm is provided with a first transmission member including a plurality of first transmission teeth configured to cooperate with the plurality of driving teeth, and the first cooperating end of the first linking arm is provided with a first cooperating member including a plurality of first cooperating teeth configured to cooperate with the plurality of driving teeth.

According to an embodiment of the present invention, the wiping device further includes a controller configured to control actuating, stopping, direction, and/or speed of rotation of the at least one power source, or to maintain the wiping device in an unfolded state.

According to an embodiment of the present invention, the first transmission end of the first transmission arm is provided with a first transmission member including a plurality of first transmission teeth, and the first cooperating end of the first linking arm is provided with a first cooperating member including a plurality of first cooperating teeth.

According to an embodiment of the present invention, the plurality of first transmission teeth are configured to rotatably mesh with the plurality of first cooperating teeth directly or indirectly.

According to an embodiment of the present invention, the wiping device further includes a first shell member to cover the first transmission member and the first cooperating member.

According to an embodiment of the present invention, the first transmission member and the first cooperating member are circular structures or elliptical structures. When the first transmission member and the first cooperating member are the elliptical structures and the wiping device is in an unfolded state, a longitudinal axis of the first transmission member is perpendicular to a longitudinal axis of the first cooperating member, and when the first transmission member and the first cooperating member are the elliptical structures and the wiping device is in a first folded state or a second folded state, the longitudinal axis of the first transmission member is perpendicular to the longitudinal axis of the first cooperating member.

According to an embodiment of the present invention, the first linking arm includes a first connecting section, a first joint and a first movable section. The first connecting section is located adjacent to the linking rod and includes the first cooperating end. The first movable section is located adjacent to the wiping rod and includes the first linking end. The first joint is disposed between the first connecting section and the first movable section and configured to allow the first movable section to move relative to the first connecting section for allowing the wiping rod to drive the wiping member to be attached onto or away from an object to be wiped.

According to an embodiment of the present invention, the first joint is provided with a first resilient member for empowering the wiping rod to drive the wiping member to be attached onto the object to be wiped.

According to an embodiment of the present invention, a length of the first transmission arm is equal to a length of the second transmission arm, and a length of the first linking arm is equal to a length of the second linking arm.

According to an embodiment of the present invention, when an object to be wiped has bilateral symmetry relative to a central axis of the object to be wiped, the rotating axis of the first cooperating end and the rotating axis of the second cooperating end are symmetrical to each other relative to the central axis of the object to be wiped.

According to an embodiment of the present invention, when the wiping device is in an unfolded state, the first transmission arm and the first linking arm are arranged parallel to each other or aligned in a same line.

According to an embodiment of the present invention, a length of the first linking arm is greater than or equal to a length of the first transmission arm.

According to an embodiment of the present invention, a difference between the length of the first linking arm and the length of the first transmission arm is half of a difference between a width of a wide side of an object to be wiped and a width of a narrow side of the object to be wiped.

According to an embodiment of the present invention, the first transmission arm and the first linking arm are located at one side of the linking rod or located at a first side and a second side of the linking rod, respectively, and when the first transmission arm and the first linking arm are located at the first side and the second side of the linking rod, respectively, the second transmission arm is located at the second side of the linking rod.

According to an embodiment of the present invention, the wiping device further includes a third transmission arm and a third linking arm. The third transmission arm is located between and parallel to the first transmission arm and the second transmission arm. The third linking arm is located between the linking rod and the wiping rod, and the third linking arm is located between and parallel to the first linking arm and the second linking arm.

According to an embodiment of the present invention, a length of the wiping rod and a length of the wiping member are equal to or less than a width of a narrow side of an object to be wiped, and a sum of a length of the first linking arm and a length of the first transmission arm is equal to or less than a height of the object to be wiped.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wiping device according to a first embodiment of the present invention.

FIG. 2 is another schematic diagram of the wiping device according to the first embodiment of the present invention.

FIG. 3 is a diagram showing the wiping device in different states according to the first embodiment of the present invention.

FIG. 4 is an enlarged diagram of an A portion of the wiping device shown in FIG. 1 according to the first embodiment of the present invention.

FIG. 5 is a partial exploded diagram of the wiping device according to the first embodiment of the present invention.

FIG. 6 is another partial exploded diagram of the wiping device according to the first embodiment of the present invention.

FIG. 7 is an enlarged diagram of a B portion of the wiping device shown in FIG. 2 according to the first embodiment of the present invention.

FIG. 8 is a functional block diagram of the wiping device according to the first embodiment of the present invention.

FIG. 9 is a partial diagram of a wiping device according to a second embodiment of the present invention.

FIG. 10 is a partial diagram of a wiping device according to a third embodiment of the present invention.

FIG. 11 is another partial diagram of the wiping device according to the third embodiment of the present invention.

FIG. 12 is a diagram of a wiping device in different states according to a fourth embodiment of the present invention.

FIG. 13 is a diagram of a wiping device in different states according to a fifth embodiment of the present invention.

FIG. 14 is a schematic diagram of a wiping device according to a sixth embodiment of the present invention.

FIG. 15 is a partial diagram of a wiping device according to a seventh embodiment of the present invention.

FIG. 16 is a partial diagram of a wiping device according to an eighth embodiment of the present invention.

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “left”, “right”, “front”, “back”, etc., is used with reference to the orientation of the Figure(s) being described. The components of the present invention can be positioned in a number of different orientations. As such, the directional terminology is used for purposes of illustration and is in no way limiting. Accordingly, the drawings and descriptions will be regarded as illustrative in nature and not as restrictive. Also, if not specified, the term “couple” or “connect” is intended to mean either an indirect or direct mechanical/electrical connection. Thus, if a first device is connected to a second device, that connection may be through a direct mechanical/electrical connection, or through an indirect mechanical/electrical connection via other devices and connections.

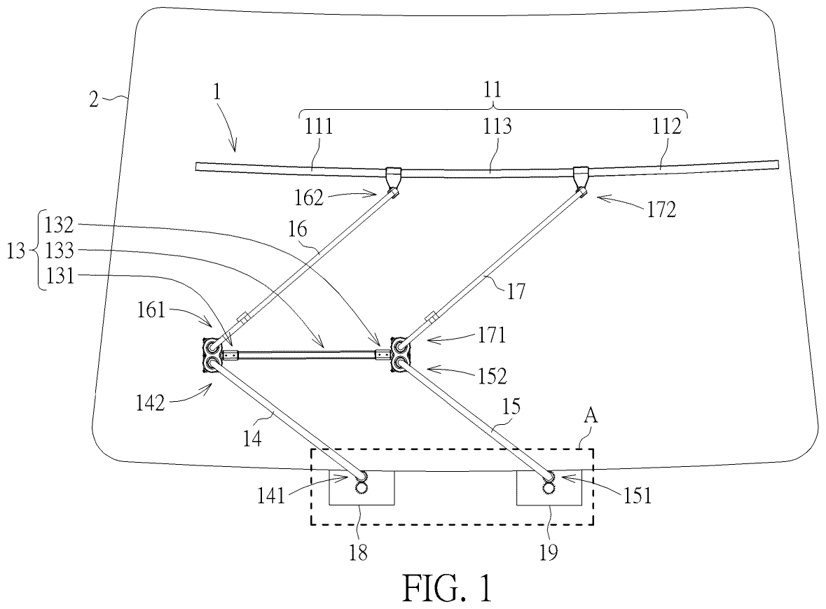

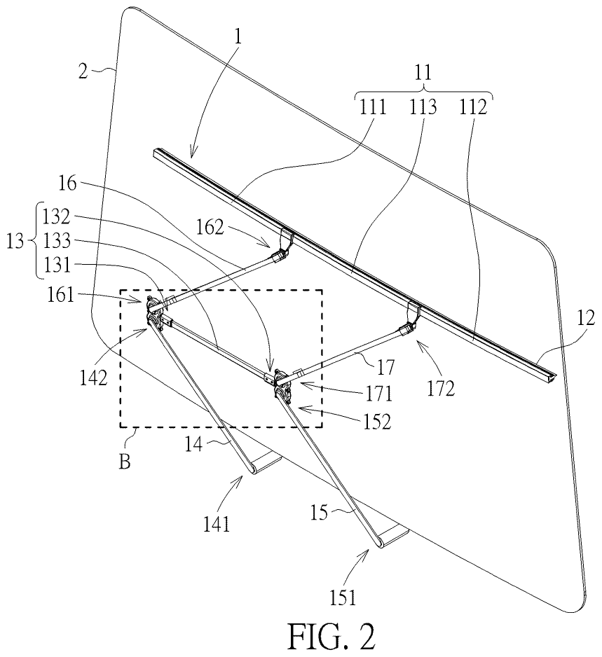

As shown in FIG. 1 to FIG. 2, in a first embodiment, a wiping device 1 is configured to wipe an object 2. The object 2 to be wiped can be a plate-shaped structure made of glass material or any translucent plastic material. The wiping device 1 includes a wiping rod 11, a wiping member 12, a linking rod 13, a first transmission arm 14, a second transmission arm 15, a first linking arm 16 and a second linking arm 17. The wiping rod 11 includes a first section 111, a second section 112 opposite to the first section 111, and a middle section 113 connected between the first section 111 and the second section 112. The wiping member 12 is mounted on the wiping rod 11 and configured to be driven by the wiping rod 11 for wiping the object 2. The linking rod 13 includes a first end portion 131, a second end portion 132 opposite to the first end portion 131, and a middle portion 133 connected between the first end portion 131 and the second end portion 132. The linking rod 13 is parallel to the wiping rod 11. The first transmission arm 14 includes a first rotating end 141 and a first transmission end 142 opposite to the first rotating end 141. The first rotating end 141 is rotatably disposed adjacent to a lower side of the object 2 to be wiped. The first transmission end 142 is rotatably connected to the first end portion 131 of the linking rod 13. The second transmission arm 15 includes a second rotating end 151 and a second transmission end 152 opposite to the second rotating end 151. The second rotating end 151 is rotatably disposed adjacent to the lower side of the object 2 to be wiped. The second transmission end 152 is rotatably connected to the second end portion 132 of the linking rod 13. The first linking arm 16 is disposed between the linking rod 13 and the wiping rod 11 and includes a first cooperating end 161 and a first linking end 162. The first cooperating end 161 is rotatably connected to the first end portion 131 of the linking rod 13 and rotatably meshed with the first transmission end 142 of the first transmission arm 14 directly or indirectly. The first linking end 162 is rotatably connected to the first section 111 of the wiping rod 11. The second linking arm 17 is disposed between the linking rod 13 and the wiping rod 11 and includes a second cooperating end 171 and a second linking end 172. The second cooperating end 171 is rotatably connected to the second end portion 132 of the linking rod 13 and rotatably meshed with the second transmission end 152 of the second transmission arm 15 directly or indirectly. The second linking end 172 is rotatably connected to the second section 112 of the wiping rod 11. An extending line through a rotating axis of the first transmission end 142 and a rotating axis of the second transmission end 152 is parallel to an extending line through a rotating axis of the first cooperating end 161 and a rotating axis of the second cooperating end 171.

As shown in FIG. 1 to FIG. 3, the first transmission arm 14 and the second transmission arm 15 are configured to swing synchronously in parallel, and the first linking arm 16 and the second linking arm 17 are configured to swing synchronously in parallel. Since the object 2 to be wiped is a bilaterally symmetrical structure, the rotating axis of the first rotating end 141 of the first transmission arm 14 and the rotating axis of the second rotating end 151 of the second transmission arm 15 are located at two opposite sides of a central vertical axis of the object 2 to be wiped and symmetrical to each other relative to the aforementioned central vertical axis.

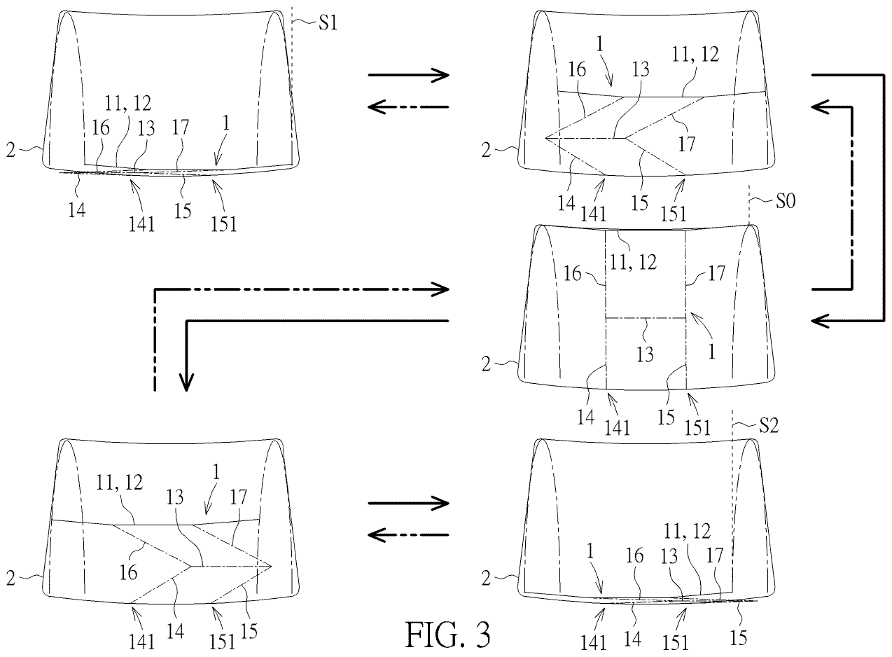

Furthermore, as shown in FIG. 1 to FIG. 3, in this embodiment, the object 2 to be wiped is a substantially isosceles trapezoid structure having an upper side narrower than the lower side. In order to enable a wiping area of the wiping device 1 to nearly cover the entire object 2 to be wiped, a length of the wiping rod 11 and a length of the wiping member 12 are substantially equal to a width of a narrow side, i.e., the upper side, of the object 2 to be wiped. Furthermore, a length of the first linking arm 16 is equal to a length of the second linking arm 17, and a length of the first transmission arm 14 is equal to a length of the second transmission arm 15. Preferably, the length of the first linking arm 16 and the length of the second linking arm 17 can be greater than the length of the first transmission arm 14 and the length of the second transmission arm 15, respectively, and a length difference between the corresponding linking arm and the corresponding transmission arm can be substantially half of a difference between a width of a wide side, i.e., the lower side, and a width of the narrow side, i.e., the upper side, of the object 2 to be wiped. Besides, a sum of a length of the corresponding linking arm and a length of the corresponding transmission arm, e.g., a sum of the length of the first linking arm 16 and the length of the first transmission arm 14, can be substantially equal to a height of the object 2 to be wiped. In such a way, when the wiping device 1 is in a first folded state S1 as shown in FIG. 3, the wiping rod 11 and the wiping member 12 are located adjacent to the lower side of the object 2 to be wiped and are offset toward one side, e.g., a right side, of the object 2 to be wiped, and when the wiping device 1 is in a second folded state S2 as shown in FIG. 3, the wiping rod 11 and the wiping member 12 are located adjacent to the lower side of the object 2 to be wiped and are offset toward the other side, e.g., a left side, of the object 2 to be wiped. Additionally, when the wiping device 1 switches from the first folded state S1 or the second folded state S2 to an unfolded state S0, the wiping rod 11 and the wiping member 12 are located adjacent to the upper side of the object 2 to be wiped and are centered relative to the object 2 to be wiped, and the first transmission arm 14 and the second transmission arm 15 are aligned with the first linking arm 16 and the second linking arm 17, respectively. In other words, when the wiping device 1 is in the unfolded state S0, a distance between the first transmission arm 14 and the second transmission arm 15 is equal to a distance between the first linking arm 16 and the second linking arm 17.

Understandably, the aforementioned wiping device can be adapted for another object which is not an isosceles-trapezoid structure. For example, when an object to be wiped is a parallelogram structure, the wiping device can move from the first folded state S1 to the unfolded state S0 and then return back to first folded state S1 (as shown in FIG. 3), or move from the second folded state S2 to the unfolded state S0 and then return back to second folded state S2 (as shown in FIG. 3), so as to maximize the wiping area of the wiping device and to cover the entire object to be wiped.

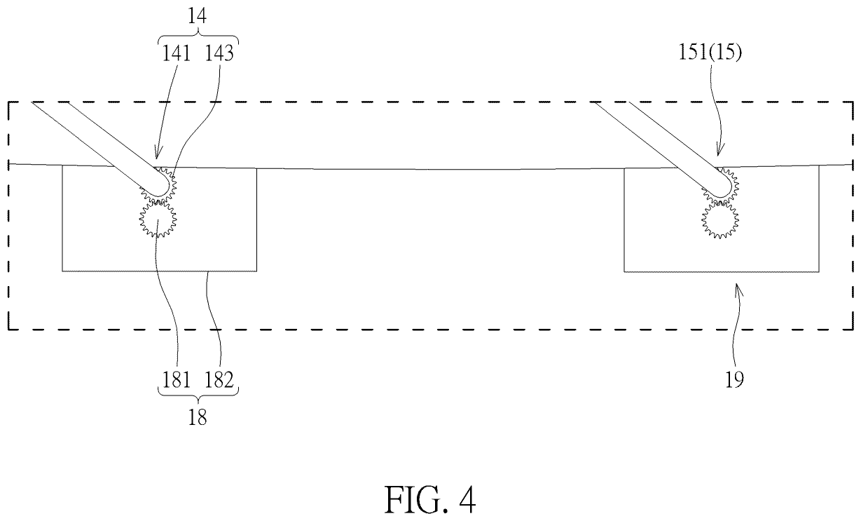

As shown in FIG. 1 and FIG. 4, the wiping device 1 further includes a first power source 18 coupled to the first rotating end 141 of the first transmission arm 14. The first power source 18 is configured to drive the first transmission arm 14 to swing back and forth to enable the wiping rod 11 to drive the wiping member 12 to wipe the object 2. It should be noticed that when the first transmission arm 14 swings back and forth, the second transmission arm 15 is driven by the linking rod 13 to swing synchronously with the first transmission arm 14. Preferably, the wiping device 1 further includes a second power source 19 coupled to the second rotating end 151 of the second transmission arm 15. The second power source 19 can act as a backup power source for driving the second transmission arm 15 to swing back and forth, and when the second transmission arm 15 swings back and forth, the first transmission arm 14 can be driven by the linking rod 13 to swing synchronously with the second transmission arm 15. Accordingly, it ensures the wiping member 12 can wipe the object 2 properly, thereby increasing reliability. However, the present invention is not limited to this embodiment. For example, in another embodiment, the wiping device can include one power source coupled to one of the first rotating end of the first transmission arm and the second rotating end of the second transmission arm only.

Specifically, as shown in FIG. 4, the first power source 18 includes a first driving member 181 and a motor 182 configured to drive the first driving member 181, and the first driving member 181 includes a plurality of driving teeth. The first rotating end 141 of the first transmission arm 14 is provided with a first driven member 143, and the first driven member 143 includes a plurality of driven teeth configured to cooperate with the plurality of driving teeth.

In this embodiment, the structures and the operational principles of the second power source 19 and the second transmission arm 15 are identical to the ones of the first power source 18 and the first transmission arm 14. Detailed description is omitted herein for simplicity.

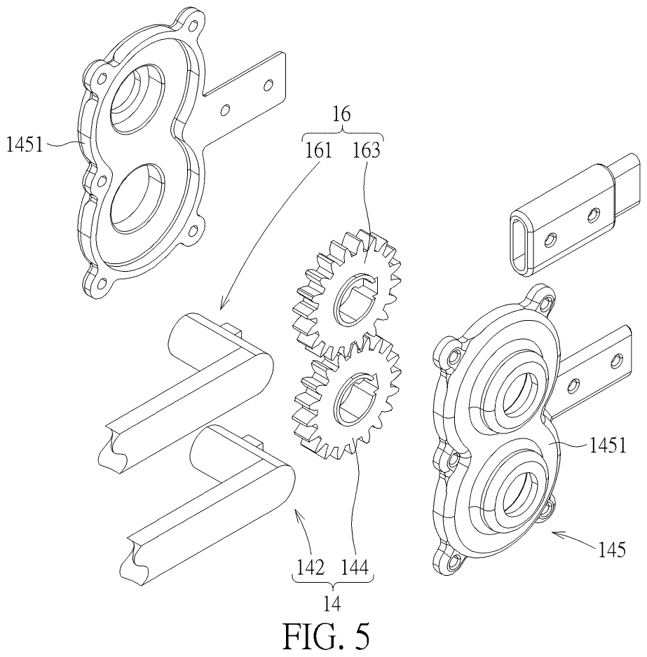

Besides, as shown in FIG. 5, the first transmission end 142 of the first transmission arm 14 is provided with a first transmission member 144, and the first transmission member 144 includes a plurality of first transmission teeth. The first cooperating end 161 of the first linking arm 16 is provided with a first cooperating member 163, and the first cooperating member 163 includes a plurality of first cooperating teeth configured to cooperate with the plurality of first transmission teeth. Preferably, the wiping device 1 further includes a first shell member 145 configured to enclose the first transmission member 144 and the first cooperating member 163 for isolating the first transmission member 144 and the first cooperating member 163 from environmental substances, such as dust or water. The first shell member 145 can include two half shell portions 1451 separable from each other for easy maintenance or replacement. More specifically, the first transmission member 144 and the first cooperating member 163 can be circular structures, e.g., circular gear wheels. The plurality of first transmission teeth of the first transmission member 144 are rotatably meshed with the plurality of first cooperating teeth of the first cooperating member 163. Since a relative position of the first transmission member 144 and the first cooperating member 163 is fixed by the linking rod 13, the first transmission arm 14 swinging back and forth drives the first linking arm 16 to swing back and forth in opposite directions. However, the present invention is not limited to this embodiment. Understandably, in another embodiment, the first transmission member and the first cooperating member can be semi-circular gear wheels, thereby providing a storage space for lubricant, such as grease or oil.

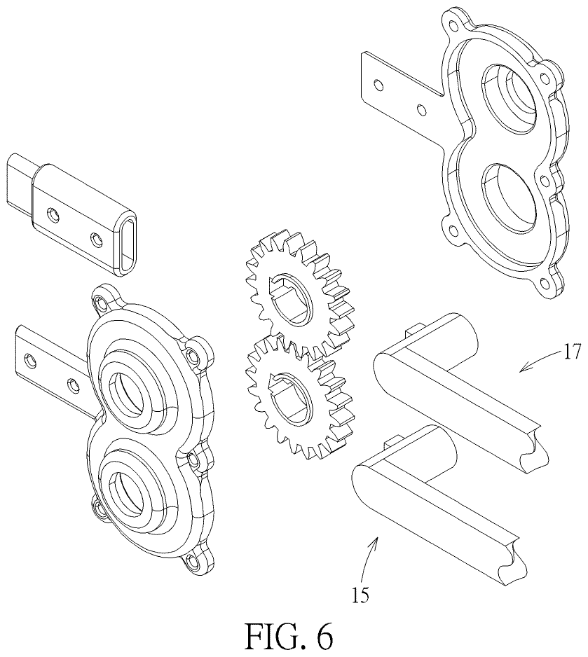

As shown in FIG. 6, in this embodiment, the structures and the operational principles of the second transmission arm 15 and the second linking arm 17 are identical to the ones of the first transmission arm 14 and the first linking arm 16. Detailed description is omitted herein for simplicity.

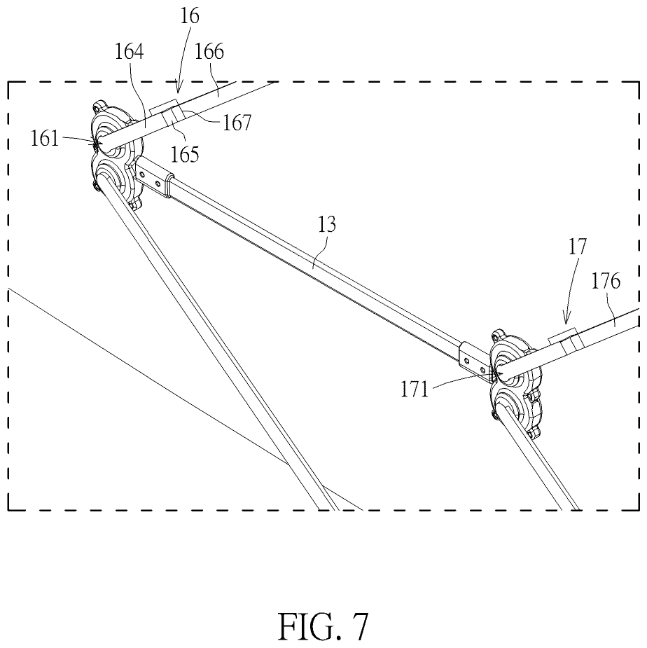

Furthermore, as shown in FIG. 2 and FIG. 7, the first linking arm 16 includes a first connecting section 164, a first joint 165 and a first movable section 166. The first connecting section 164 is located adjacent to the linking rod 13 and includes the first cooperating end 161. The first movable section 166 is located adjacent to the wiping rod 11 and includes the first linking end 162. The first joint 165 is disposed between the first movable section 166 and the first connecting section 164 and configured to allow the first movable section 166 to move relative to the first connecting section 164 for allowing the wiping rod 11 to drive the wiping member 12 to be attached onto or away from the object 2 to be wiped. Preferably, a first resilient member 167 is arranged on the first joint 165 for empowering the wiping rod 11 to drive the wiping member 12 to be attached onto the object 2 to be wiped, i.e., the first resilient member 167 intends to resiliently drive the wiping member 12 to be attached onto the object 2 to be wiped.

In this embodiment, the structures and the operational principles of the second linking arm 17, the linking rod 13 and the wiping rod 11 are identical to the ones of the first linking arm 16, the linking rod 13 and the wiping rod 11. Detailed description is omitted herein for simplicity.

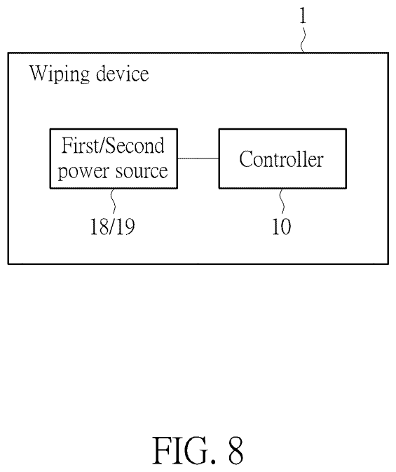

Moreover, for easy replacement of the wiping member 12, as shown in FIG. 2, FIG. 3, FIG. 7 and FIG. 8, in this embodiment, the wiping device 1 further includes a controller 10, e.g., a control circuit board, electrically connected to the first power source 18 and/or the second power source 19. The controller 10 is configured to receive signals to control the first power source 18 and/or the second power source 19 to maintain the wiping device 1 in the unfolded state S0, thereby allowing a user to move the wiping rod 11 and the wiping member 12 from the object 2 to be wiped by operating at least one of the first movable section 166 of the first linking arm 16, a second movable section of the second linking arm 17 and the wiping rod 11 easily. Additionally, the controller 10 can be further configured to control actuating, stopping, direction, and/or speed of rotation of the first power source and/or the second power source.

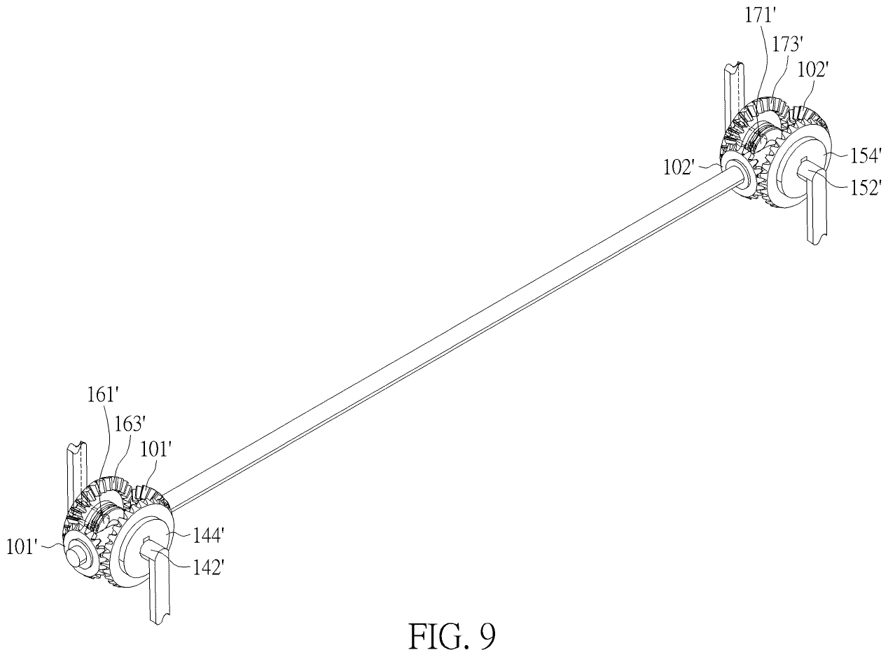

As shown in FIG. 9, different from the first embodiment, in a second embodiment, a plurality of first transmission teeth of a first transmission member 144′ of a first transmission arm and a plurality of first cooperating teeth of a first cooperating member 163′ of a first linking arm are not rotatably meshed with each other directly, and a plurality of second transmission teeth of a second transmission member 154′ of a second transmission arm and a plurality of second cooperating teeth of a second cooperating member 173′ of a second linking arm are not rotatably meshed with each other directly. Specifically, in this embodiment, a wiping device 1′ further includes a first transmission meshing member 101′ and a second transmission meshing member 102′. A plurality of first meshing teeth of the first transmission meshing member 101′ are rotatably meshed with the plurality of first transmission teeth of the first transmission member 144′ and the plurality of first cooperating teeth of the first cooperating member 163′. A plurality of second meshing teeth of the second transmission meshing member 102′ are rotatably meshed with the plurality of second transmission teeth of the second transmission member 154′ and the plurality of second cooperating teeth of the second cooperating member 173′. Besides, an extending line through a rotating axis of a first transmission end 142′ and a rotating axis of a second transmission end 152′ is coincided with an extending line through a rotating axis of a first cooperating end 161′ and a rotating axis of a second cooperating end 171′. It should be noticed that the numbers and the shapes of the first transmission meshing member 101′ and the second transmission meshing member 102′ are not limited to those illustrated in the figure of this embodiment. It depends on practical demands.

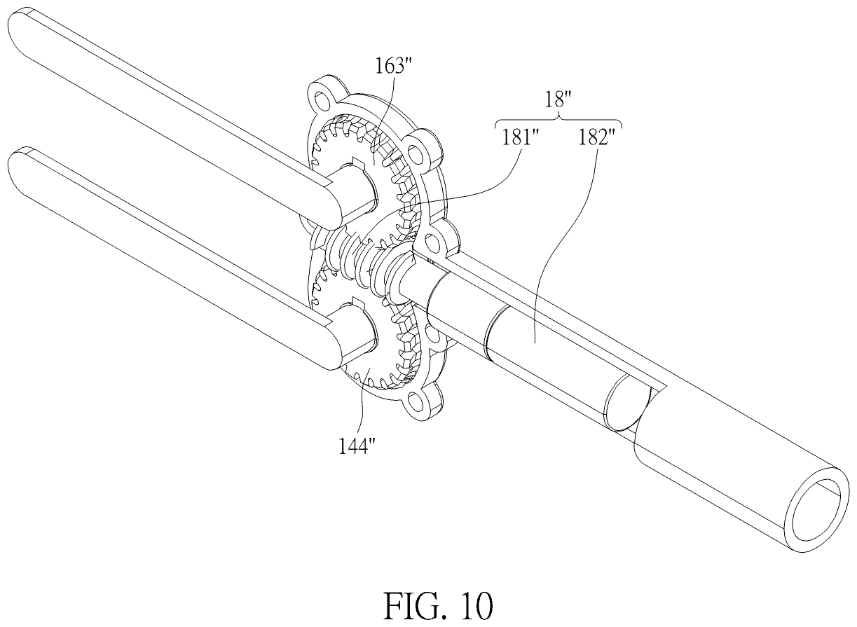

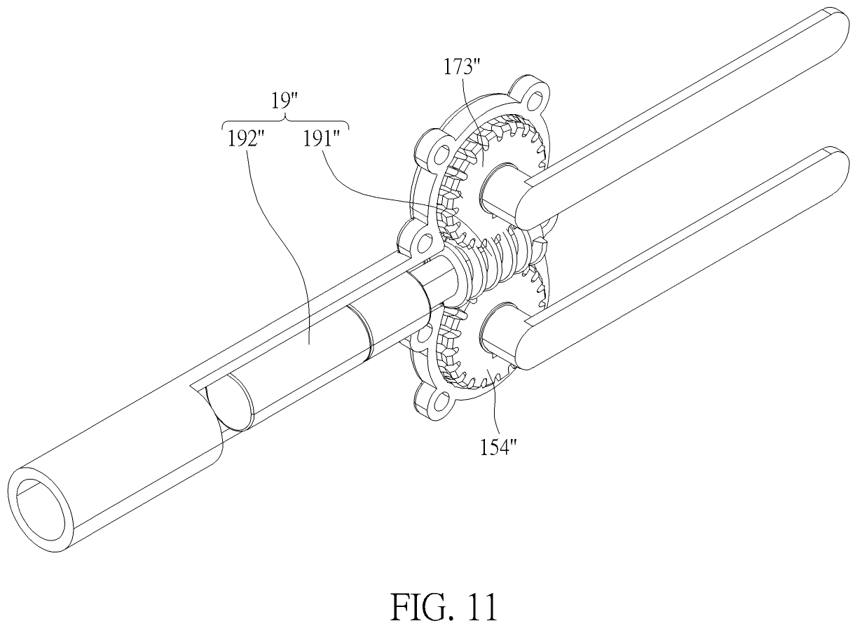

As shown in FIG. 10 and FIG. 11, different from the first embodiment, in a third embodiment, a motor 182″ of a first power source 18″ and a motor 192″ of a second power source 19″ are disposed inside a linking rod 13″. A first driving member 181″ of the first power source 18″ is located between a first transmission member 144″ and a first cooperating member 163″. A second driving member 191″ of the second power source 19″ is located between a second transmission member 154″ and a second cooperating member 173″. A plurality of first transmission teeth of the first transmission member 144″ and a plurality of first cooperating teeth of the first cooperating member 163″ cooperate with a plurality of first driving teeth of the first driving member 181″. A plurality of second transmission teeth of the second transmission member 154″ and a plurality of second cooperating teeth of the second cooperating member 173″ cooperate with a plurality of first driving teeth of the second driving member 191″. Understandably, one of the first power source 18″ and the second power source 19″ can be selectively omitted. Furthermore, it should be noticed that, in this embodiment, the first driving member 181″ and the second driving member 191″ can be worm gear rods, and the first transmission member 144″, the second transmission member 154″, the first cooperating member 163″ and the second cooperating member 173″ can be worm gear wheels. In another embodiment, the first driving member, the second driving member, the first transmission member, the second transmission member, the first cooperating member and the second cooperating member can be bevel gear wheels similar to the first transmission meshing member, the second transmission meshing member, the first transmission member, the second transmission member, the first cooperating member and the second cooperating member of the second embodiment, respectively.

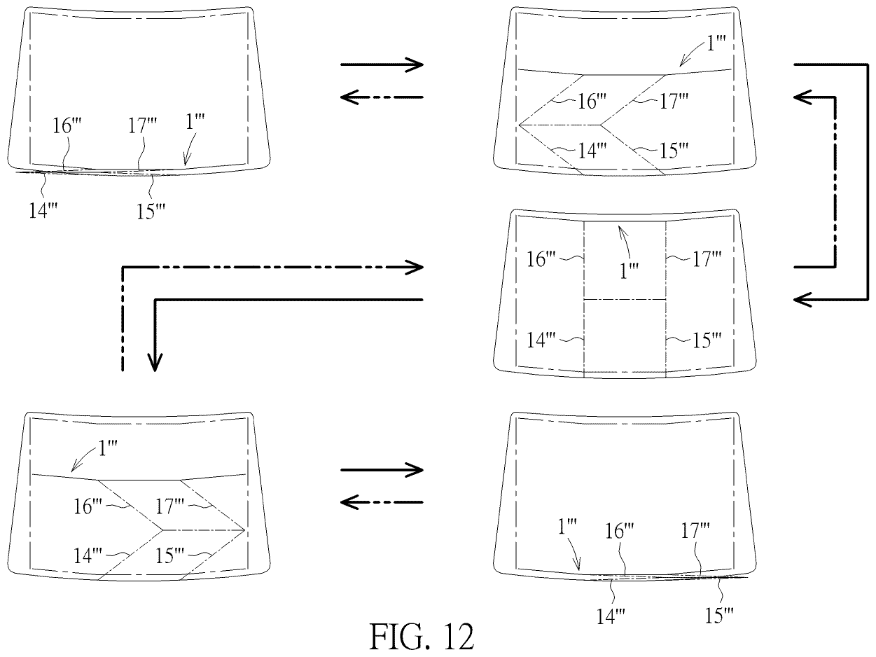

As shown in FIG. 12, different from the first embodiment, in a fourth embodiment, a length of a first linking arm 16′″ is equal to a length of a first transmission arm 14′″, and a length of a second linking arm 17′″ is equal to a length of a second transmission arm 15′″, such that a wiping area of a wiping device 1′″ is formed in a rectangular shape as illustrated by dash lines, so as to meet the need for wiping a rectangular windshield.

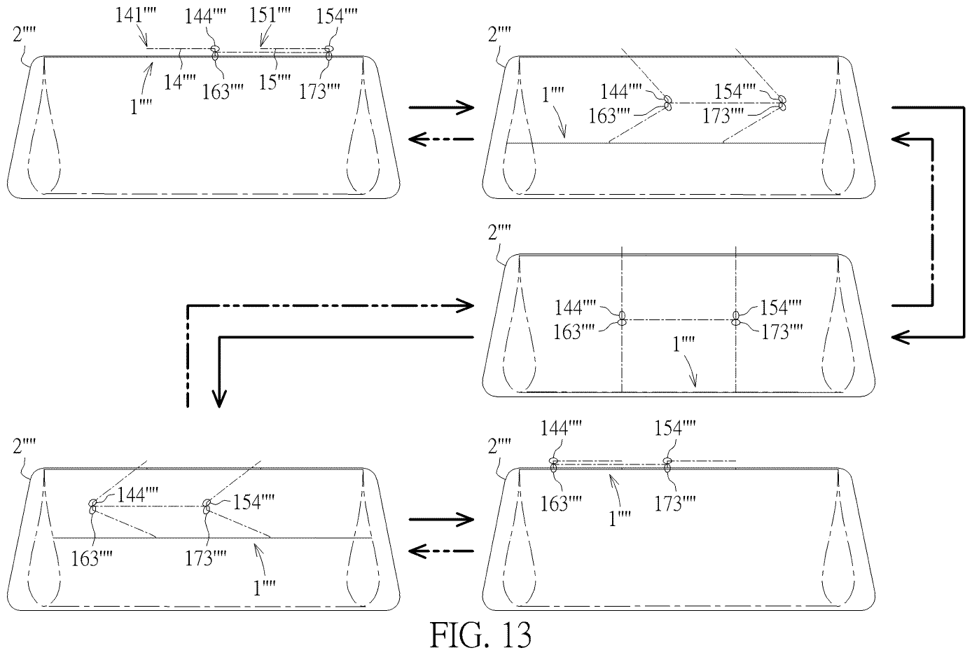

As shown in FIG. 13, different from the first embodiment, in a fifth embodiment, a first rotating end 141″″ of a first transmission arm 14″″ and a second rotating end 151″″ of a second transmission arm 15″″ are disposed adjacent to an upper side of an object 2″″ to be wiped, and a first transmission member 144″″ and a first cooperating member 163″″ can be ellipse structures. When a wiping device 1″″ is in an unfolded state, a longitudinal axis of the first transmission member 144″″ and a longitudinal axis of the first cooperating member 163″″ are perpendicular to each other and arranged vertically and horizontally, respectively. When the wiping device 1″″ is in a first folded state or a second folded state, the longitudinal axis of the first transmission member 144″″ and the longitudinal axis of the first cooperating member 163″″ are perpendicular to each other and arranged horizontally and vertically, respectively. The structures and the operational principles of a second transmission member 154″″ and a second cooperating member 173″″ are identical to the ones of the first transmission member 144″″ and the first cooperating member 163″″. Detailed description is omitted herein for simplicity. Such configuration achieves a wiping area of the wiping device 1″″ to be formed in a trapezoid shape having a upper narrow side and a lower wide side to cover an object 2″″ to be wiped, so as to meet the need for wiping a rear windshield with the top mounted wiping device 1″″.

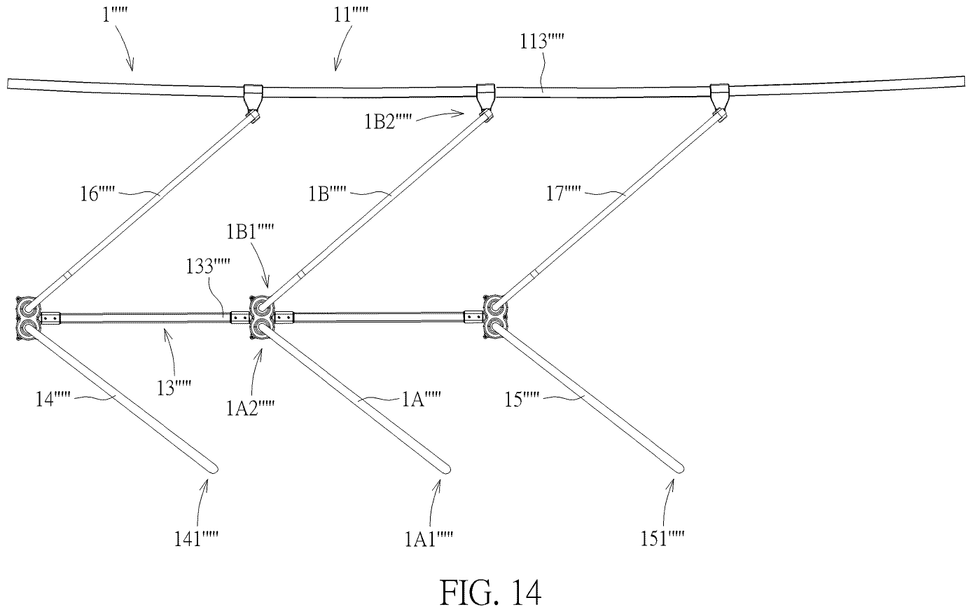

As shown in FIG. 14, different from the first embodiment, in a sixth embodiment, a wiping device 1′″″ further includes a third transmission arm 1A′″″ and a third linking arm 1B′″″. The third transmission arm 1A′″″ is disposed between the first transmission arm 14′″″ and the second transmission arm 15′″″ and includes a third rotating end 1A1′″″ and a third transmission end 1A2′″″ opposite to the third rotating end 1A1′″″. The third rotating end 1A1′″″ is rotatably disposed between a first rotating end 141′″″ and a second rotating end 151′″″. The third transmission end 1A2′″″ is rotatably connected to a middle portion 133′″″ of a linking rod 13′″″. The third linking arm 1B′″″ is disposed between the linking rod 13′″″ and a wiping rod 11′″″ and between a first linking arm 16′″″ and a second linking arm 17′″″. The third linking arm 1B′″″ includes a third cooperating end 1B1′″″ and a third linking end 1B2′″″ opposite to the third cooperating end 1B1′″″. The third cooperating end 1B1′″″ is rotatably connected to the middle portion 133′″″ of the linking rod 13′″″ and rotatably meshed with the third transmission end 1A2′″″ of the third transmission arm 1A′″″ directly or indirectly. The third linking end 1B2′″″ is rotatably connected to a middle section 113′″″ of the wiping rod 11′″″. Preferably, all three transmission arms have equal lengths and are parallel to one another, and all three linking arms have equal lengths and are parallel to one another. Such configuration enables a first section 111″″, a second section 112′″″ and the middle section 113′″″ of the wiping rod 11′″″ to be stably supported by the first linking arm 16′″″, the second linking arm 17′″″ and the third linking arm 1B′″″, respectively, to prevent the wiping rod 11′″″ from being bent or broken and to allow the wiping rod 11″″ to be uniformly forced, so as to meet the need for wiping a wide front windshield of a bus or a truck.

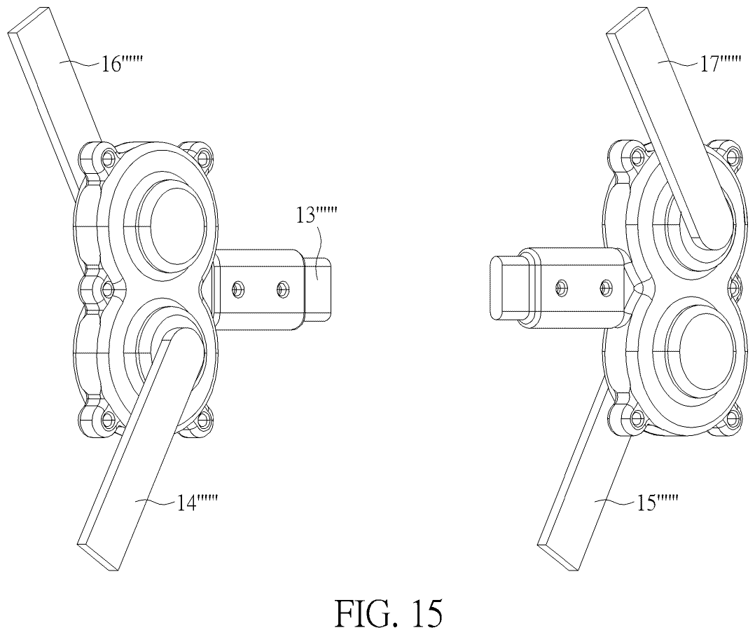

As shown in FIG. 15, different from the first embodiment, in a seventh embodiment, a first transmission arm 14″″″ and a first linking arm 16″″″ are located at different sides of a linking rod 13″″″. The first transmission arm 14″″″ and a second transmission arm 15″″″ are located at different sides of the linking rod 13″″″. The second transmission arm 15″″″ and a second linking arm 17″″″ are located at different sides of the linking rod 13″″″. It prevents any collision of the first transmission arm 14″″″, the second transmission arm 15″″″, the first linking arm 16″″″ and the second linking arm 17″″″ when a wiping device is in a first folded state or a second folded state. Specifically, in this embodiment, the first transmission arm 14″″″ and the second linking arm 17″″″ can be located at a front side of the linking rod 13″″″, and the second transmission arm 15″″″ and the first linking arm 16″″″ can be located at a rear side of the linking rod 13″″″. However, the present invention is not limited to this embodiment.

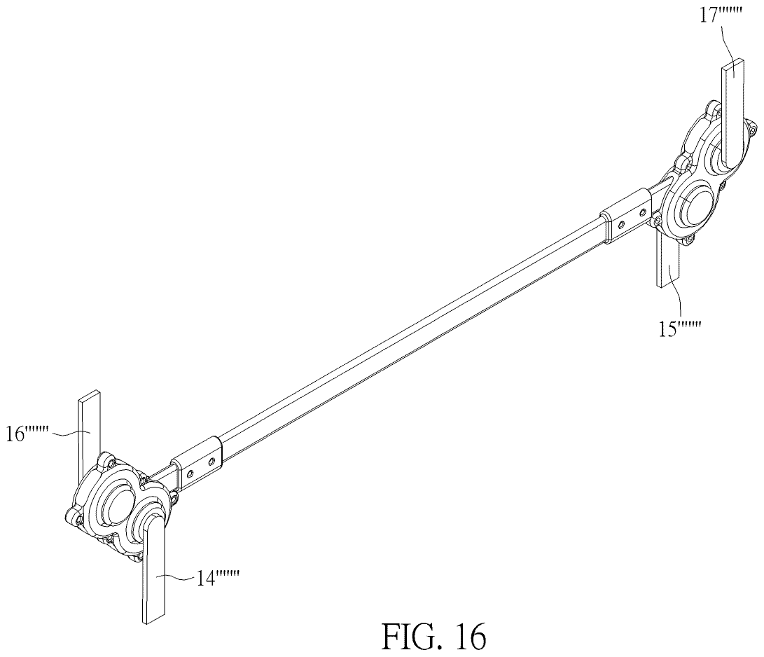

Additionally, as shown in FIG. 16, different from the first embodiment, in an eighth embodiment, a first transmission arm 14′″″″ and a first linking arm 16′″″″ are located at different sides of a linking rod 13′″″″. The first transmission arm 14′″″″ and a second transmission arm 15′″″″ are located at different sides of the linking rod 13′″″″. The second transmission arm 15′″″″ and a second linking arm 17′″″″ are located at different sides of the linking rod 13′″″″. The aforementioned configuration is similar to the seventh embodiment. Besides, when a wiping device is in an unfolded state, the first transmission arm 14′″″″ and the first linking arm 16′″″″ are parallel to each other, and the second transmission arm 15′″″″ and the second linking arm 17′″″″ are parallel to each other. However, a distance between the first transmission arm 14′″″″ and the second transmission arm 15′″″″ is unequal to, e.g., less than, a distance between the first linking arm 16′″″″ and the second linking arm 17′″″″.

Understandably, in another embodiment, if circumstances permit, e.g., the wiping device is adapted for a ship or an engineering vehicle, the first rotating end and the second rotating end can be rotatably disposed adjacent to a lateral side, e.g., a left side or a right side, of the object to be wiped, thereby allowing the wiping rod to drive the wiping member to wipe the object from left to right or from right to left and then to be folded at the left side or right side of the object.

In contrast to the prior art, the wiping device of the present invention includes the following characteristics.
(1) Lengths of the linking rod, the transmission arm and the linking arm of the wiping device of the present invention can be adjusted according to a shape of the object to be wiped for making a wiping area nearly cover the entire object to be wiped, so as to provide a clear view for a driver or a passenger in adverse weather conditions.
(2) The linking rod of the wiping device of the present invention is disposed outside an engine compartment, and the present invention does not need any internal linking mechanism inside the engine compartment. Therefore, the present invention occupies less space of the engine compartment, or even does not require any space in the engine compartment.
(3) The conventional wiping device is typically configured to not be hidden under an engine hood when being folded for the reason of easy replacement of the wiping member. However, the wiping device of the present invention is configured to be unfolded for easy replacement of the wiping member. Therefore, the wiping device of the present invention can be hidden under the engine hood without concerns when being in the folded state, thereby achieving both a streamlined appearance and improved aerodynamic effect.
(4) The wiping device of the invention uses the shell member to cover the transmission members and the cooperating members for isolating the transmission members and the cooperating members from the environmental substances, such as dust or water, thereby ensuring durability.
(5) The wiping device of the present invention has symmetry relative to the central longitudinal axis of the object to be wiped. Therefore, there is no need for significant design changes in vehicle bodies of left-hand drive and right-hand drive vehicles.
(6) The wiping device of the present invention avoids using any sliding track, any cable, or any chain, which is prone to blockage, breakage, and wear and tear, thereby ensuring better durability.
(7) The wiping device of the present invention never pauses in front of the driver while reversing but folds at the bottom or top of the windshield when a wiping motion reverses. Therefore, it prevents providing an obstructed view.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wiping device comprising:
a wiping rod comprising a first section and a second section opposite to the first section;
a wiping member mounted on the wiping rod;
a linking rod comprising a first end portion and a second end portion opposite to the first end portion, a length direction of the linking rod being parallel to a length direction of the wiping rod;
a first transmission arm comprising a first rotating end and a first transmission end opposite to the first rotating end and rotatably connected to the first end portion of the linking rod;
a second transmission arm arranged parallel to the first transmission arm, the second transmission arm comprising a second rotating end and a second transmission end opposite to the second rotating end and rotatably connected to the second end portion of the linking rod;
a first linking arm disposed between the linking rod and the wiping rod and comprising a first cooperating end and a first linking end, the first cooperating end being rotatably connected to the first end portion of the linking rod and rotatably meshed with the first transmission end of the first transmission arm directly or indirectly, the first linking end being rotatably connected to the first section of the wiping rod; and
a second linking arm disposed between the linking rod and the wiping rod and comprising a second cooperating end and a second linking end, the second cooperating end being rotatably connected to the second end portion of the linking rod and rotatably meshed with the second transmission end of the second transmission arm directly or indirectly, the second linking end being rotatably connected to the second section of the wiping rod, an extending line through a rotating axis of the first transmission end and a rotating axis of the second transmission end being parallel to or coincided with an extending line through a rotating axis of the first cooperating end and a rotating axis of the second cooperating end.

2. The wiping device of claim 1, further comprising at least one power source coupled to at least one of the first transmission arm and the second transmission arm.

3. The wiping device of claim 2, wherein the at least one power source comprises a first power source, the first power source comprises a first driving member comprising a plurality of driving teeth, and the first rotating end of the first transmission arm is provided with a first driven member comprising a plurality of driven teeth configured to cooperate with the plurality of driving teeth.

4. The wiping device of claim 2, wherein the at least one power source comprises a first power source, the first power source comprises a first driving member comprising a plurality of driving teeth, the first transmission end of the first transmission arm is provided with a first transmission member comprising a plurality of first transmission teeth configured to cooperate with the plurality of driving teeth, and the first cooperating end of the first linking arm is provided with a first cooperating member comprising g a plurality of first cooperating teeth configured to cooperate with the plurality of driving teeth.

5. The wiping device of claim 2, further comprising a controller configured to control actuating, stopping, direction, and/or speed of rotation of the at least one power source, or to maintain the wiping device in an unfolded state.

6. The wiping device of claim 1, wherein the first transmission end of the first transmission arm is provided with a first transmission member comprising a plurality of first transmission teeth, and the first cooperating end of the first linking arm is provided with a first cooperating member comprising a plurality of first cooperating teeth.

7. The wiping device of claim 6, wherein the plurality of first transmission teeth are configured to rotatably mesh with the plurality of first cooperating teeth directly or indirectly.

8. The wiping device of claim 6, further comprising a first shell member to cover the first transmission member and the first cooperating member.

9. The wiping device of claim 6, wherein the first transmission member and the first cooperating member are circular structures or elliptical structures, when the first transmission member and the first cooperating member are the elliptical structures and the wiping device is in an unfolded state, a longitudinal axis of the first transmission member is perpendicular to a longitudinal axis of the first cooperating member, and when the first transmission member and the first cooperating member are the elliptical structures and the wiping device is in a first folded state or a second folded state, the longitudinal axis of the first transmission member is perpendicular to the longitudinal axis of the first cooperating member.

10. The wiping device of claim 1, wherein the first linking arm comprises a first connecting section, a first joint and a first movable section, the first connecting section is located adjacent to the linking rod and comprises the first cooperating end, the first movable section is located adjacent to the wiping rod and comprises the first linking end, the first joint is disposed between the first connecting section and the first movable section and configured to allow the first movable section to move relative to the first connecting section for allowing the wiping rod to drive the wiping member to be attached onto or away from an object to be wiped.

11. The wiping device of claim 10, wherein the first joint is provided with a first resilient member for biasing the wiping rod to drive the wiping member to be attached onto the object to be wiped.

12. The wiping device of claim 1, wherein a length of the first transmission arm is equal to a length of the second transmission arm, and a length of the first linking arm is equal to a length of the second linking arm.

13. The wiping device of claim 1, wherein when an object to be wiped has bilateral symmetry relative to a central axis of the object to be wiped, the rotating axis of the first cooperating end and the rotating axis of the second cooperating end are symmetrical to each other relative to the central axis of the object to be wiped.

14. The wiping device of claim 1, wherein when the wiping device is in an unfolded state, the first transmission arm and the first linking arm are arranged parallel to each other or aligned in a same line.

15. The wiping device of claim 1, wherein a length of the first linking arm is greater than or equal to a length of the first transmission arm.

16. The wiping device of claim 15, wherein a difference between the length of the first linking arm and the length of the first transmission arm is half of a difference between a width of a wide side of an object to be wiped and a width of a narrow side of the object to be wiped.

17. The wiping device of claim 1, wherein the first transmission arm and the first linking arm are located at one side of the linking rod or located at a first side and a second side of the linking rod, respectively, and when the first transmission arm and the first linking arm are located at the first side and the second side of the linking rod, respectively, the second transmission arm is located at the second side of the linking rod.

18. The wiping device of claim 1, further comprising:
a third transmission arm located between and parallel to the first transmission arm and the second transmission arm; and
a third linking arm located between the linking rod and the wiping rod, and the third linking arm being located between and parallel to the first linking arm and the second linking arm.

19. The wiping device of claim 1, wherein a length of the wiping rod and a length of the wiping member are equal to or less than a width of a narrow side of an object to be wiped, and a sum of a length of the first linking arm and a length of the first transmission arm is equal to or less than a height of the object to be wiped.
